(19) United States
(12) Patent Application Publication
(10) Pub. No.: US 2025/0277670 A1
(43) Pub. Date: Sep. 4, 2025

(54) VEHICLE FOR PREGNANT WOMEN AND CONTROL METHOD THEREOF

(71) Applicants: Hyundai Motor Company, Seoul (KR); Kia Corporation, Seoul (KR)

(72) Inventors: Yong Joo LEE, Hwaseong-Si (KR); Sung Bae Jeon, Hwaseong-Si (KR); Dae Yeong Kim, Hwaseong-Si (KR); Tae Hyun Lee, Yongin-Si (KR); Do Hwa Kim, Seoul (KR); Gyu Ri Lee, Namyangju-Si (KR)

(73) Assignees: Hyundai Motor Company, Seoul (KR); Kia Corporation, Seoul (KR)

(21) Appl. No.: 18/798,239

(22) Filed: Aug. 8, 2024

(30) Foreign Application Priority Data
Feb. 29, 2024 (KR) 10-2024-0030037

(51) Int. Cl. G01C 21/36; B60W 50/08; G01C 21/34

(52) U.S. Cl. CPC G01C 21/3617; B60W 50/082; G01C 21/3407; G01C 21/3679; B60W 2720/106

(57) ABSTRACT

For a vehicle capable of offering various functions during emergency situations for pregnant women and a control method thereof, a method for controlling a vehicle may include determining whether a pregnant woman is on board, and performing, based on the determination of the pregnant woman being on board and an emergency mode entry command being input, emergency mode control, wherein the emergency mode control may include route guidance control to an emergency destination determined based on a predetermined criteria, and emergency driving control to selectively control an acceleration-inhibiting driving assistance function to the determined emergency destination.

### CROSS REFERENCE TO RELATED APPLICATION

The present application claims priority to Korean Patent Application No. 10-2024-0030037, filed on Feb. 29, 2024, the entire contents of which is incorporated herein for all purposes by this reference.

### BACKGROUND OF THE PRESENT DISCLOSURE

### Field of the Present Disclosure

The present disclosure relates to a vehicle capable of offering various functions during emergency situations for pregnant women and a control method thereof.

### Description of Related Art

In many countries, wearing seat belts while driving is mandatory. However, pregnant women may experience discomfort to their spine and fetus when wearing conventional seat belts, and in some cases, not wearing them might pose even greater risks. Therefore, exceptions to the mandatory seat belt requirement are sometimes applied, and various vehicle products that do not exert pressure on the abdomen, such as safety belts designed for pregnant women, have been introduced. However, there is still a lack of driving modes and vehicle control technologies that take into account the needs of pregnant women.

For example, in emergency situations such as signs of labor occurring in a vehicle with a pregnant passenger, both the driver and occupants may experience extreme tension, impairing their judgment and ability to react, necessitating driving modes and control technologies that prioritize the safety of the pregnant woman and allow reaching the destination with minimal manipulation.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure is directed to providing a vehicle configured for offering various functions during emergency situations for pregnant women and a control method thereof.

The technical objects of an exemplary embodiment of the present disclosure are not limited to the aforesaid, and other objects not described herein with be clearly understood by those skilled in the art from the descriptions below.

In order In various aspects of the present disclosure, a method for controlling a vehicle according to an exemplary embodiment of the present disclosure may include determining whether a pregnant woman is on board, and performing, based on the determination of the pregnant woman being on board and an emergency mode entry command being input, emergency mode control, wherein the emergency mode control may include route guidance control to an emergency destination determined based on a predetermined criteria, and emergency driving control to selectively control an acceleration-inhibiting driving assistance function to the determined emergency destination.

For example, the performing of the emergency mode control may include deactivating the acceleration-inhibiting driving assistance function to the emergency destination.

For example, the acceleration-inhibiting driving assistance function may include at least one of navigation-based smart cruise control (NSCC), intelligent speed limit assist (ISLA) for limiting the maximum vehicle speed to a set speed, or manual speed limit assist (MSLA).

For example, the predetermined criteria may include route factors and facility factors scored for each of at least one emergency destination candidate.

For example, the route factors may include location and road information along a route of the vehicle for each emergency destination candidate, and the facility factors may include at least one of size, number of beds, availability of emergency rooms, and medical departments for each emergency destination candidate.

For example, the determining of whether a pregnant woman is on board may include determining whether a profile with the pregnant woman setting applied is selected.

For example, the method may further include performing, based on the determination of the pregnant woman being on board, emergency mode preparation control inclusive of changing navigation settings.

For example, the performing of the emergency mode preparation control may include displaying a menu for entering the emergency mode on the display of a navigation device.

For example, the emergency mode control may further include performing sound control including at least one of outputting predetermined audio and activating active noise cancellation, and initiating emergency contact to the determined emergency destination and a predetermined contact.

Furthermore, a vehicle according to various exemplary embodiments of the present disclosure may include an advanced driver assistance system (ADAS) controller; an audio/video/navigation/telematics (AVNT) terminal; and an emergency mode controller operatively connected to the ADAS controller and the AVNT terminal and configured to perform, based on the determination of the pregnant woman being on board and an emergency mode entry command being input, emergency mode control including route guidance control and emergency mode control. Here, the route guidance control may include guiding the route to a determined emergency destination via the AVNT terminal based on a predetermined criteria, and the emergency driving control may include selectively controlling an acceleration-inhibiting driving assistance function provided through the ADAS controller to the determined emergency destination.

For example, the emergency mode controller may deactivate the acceleration-inhibiting driving assistance function to the emergency destination.

For example, the acceleration-inhibiting driving assistance function may include at least one of navigation-based smart cruise control (NSCC), intelligent speed limit assist (ISLA) for limiting the maximum vehicle speed to a set speed, or manual speed limit assist (MSLA).

For example, the predetermined criteria may include route factors and facility factors scored for each of at least one emergency destination candidate.

For example, the route factors may include location and road information along a route of the vehicle for each emergency destination candidate, and the facility factors may include at least one of size, number of beds, availability of emergency rooms, and medical departments for each emergency destination candidate.

For example, the emergency mode controller may be configured to determine whether a profile with the pregnant woman setting applied is selected.

For example, the emergency mode controller may perform, based on the determination of the pregnant woman being on board, emergency mode preparation control inclusive of changing navigation settings.

For example, the changing of the navigation settings may include displaying a menu for entering the emergency mode on the display of the AVNT terminal.

For example, the emergency mode control may further include performing sound control including at least one of outputting predetermined audio and activating active noise cancellation, and initiating emergency contact to the determined emergency destination and a predetermined contact.

For example, the emergency mode controller may include at least one of a hybrid control unit (HCU) for hybrid vehicles and a vehicle control unit (VCU) for an electric vehicles.

According to at least an exemplary embodiment of the present disclosure, various functions may be provide for emergency situations of pregnant women in a vehicle.

An optimal emergency destinations may be proposed and guided during emergencies, with driving control implemented to ensure safe and prompt arrival at the destination.

The advantageous effects which may be obtained in an exemplary embodiment of the present disclosure are not limited to the aforesaid, and other effects not described herein with may be clearly understood by those skilled in the art from the descriptions below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a configuration of a vehicle applicable to the embodiments;

FIG. 2 is a schematic diagram illustrating a conceptual outline of emergency mode control according to an exemplary embodiment of the present disclosure;

FIG. 3 is a diagram exemplifying emergency mode control according to an exemplary embodiment of the present disclosure;

FIG. 4 is a diagram illustrating a method for determining the optimal emergency destination according to an exemplary embodiment of the present disclosure;

FIG. 5 is a flowchart illustrating an exemplary process of emergency mode control according to an exemplary embodiment of the present disclosure; and

FIG. 6 is an exemplary screen display of navigation setting changed based on the determination of pregnant women boarding according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, descriptions are made of the exemplary embodiments disclosed in the present specification with reference to the accompanying drawings in which the same reference numbers are assigned to refer to the same or like components and redundant description thereof is omitted. As used in the following description, the suffix “module” and “unit” are granted or used interchangeably in consideration of easiness of description but, by itself, having no distinct meaning or role. Furthermore, detailed descriptions of well-known technologies related to the exemplary embodiments disclosed in the present specification may be omitted to avoid obscuring the subject matter of the exemplary embodiments disclosed in the present specification. Furthermore, the accompanying drawings are only for easy understanding of the exemplary embodiments disclosed in the present specification and do not limit the technical spirit disclosed herein, and it should be understood that the exemplary embodiments include all changes, equivalents, and substitutes within the spirit and scope of the present disclosure.

As used herein, terms including an ordinal number such as “first” and “second” may be used to describe various components without limiting the components. The terms are used only for distinguishing one component from another component.

It will be understood that when a component is referred to as being “connected to” or “coupled to” another component, it may be directly connected or coupled to the other component or intervening component may be present. In contrast, when a component is referred to as being “directly connected to” or “directly coupled to” another component, there are no intervening component present.

As used herein, the singular forms are intended to include the plural forms as well, unless the context clearly indicates otherwise.

It will be further understood that the terms “comprises” or “has,” when used in the present specification, specify the presence of a stated feature, number, step, operation, component, element, or a combination thereof, but they do not preclude the presence or addition of one or more other features, numbers, steps, operations, components, elements, or combinations thereof.

Furthermore, it should be noted that the terms “unit” or “control unit” found in the names of motor control units (MCUs) or similar devices are typically used to describe controllers responsible for specific functions of a vehicle, rather than indicating a generic function unit. For example, each controller may include a communication device communicating with another controller or sensor to control a function in charge, a memory that stores operating system or logic instructions and input/output information, and one or more processors for determination, operation, and decision-making necessary for functions in charge. Furthermore, the term “terminal” mentioned below may also include a configuration similar to that of a controller.

The exemplary embodiments of the present disclosure propose activating emergency mode preparation control upon detecting the presence of a pregnant woman on board, and in response to an emergency mode entry command, providing route guidance to the emergency destination and suitable driving control of the vehicle for emergency situations.

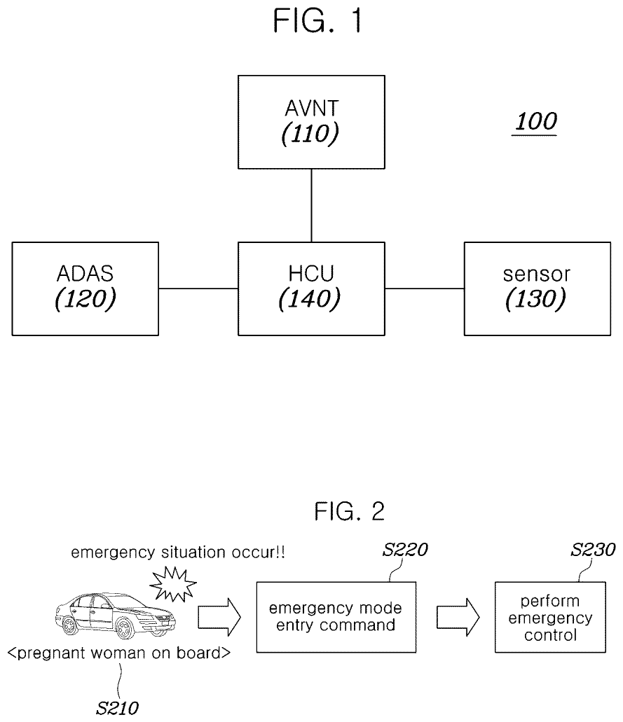

First, a description includes the configuration of a vehicle applicable to the exemplary embodiments with reference to FIG. 1.

FIG. 1 is a diagram illustrating a configuration of a vehicle applicable to the embodiments.

It is assumed that the configuration depicted in FIG. 1 represents a hybrid electric vehicle (HEV). However, the present example is provided for explanatory purposes, and the concept is also applicable to vehicles with other forms of powertrains, such as electric vehicles (EVs) or internal combustion engine vehicles.

With reference to FIG. 1, the vehicle according to various exemplary embodiments of the present disclosure may include an audio/video/navigation/telematics (AVNT) terminal 110, an advanced driver assistance system (ADAS) controller 120, sensors 130, and a hybrid control (HCU) 140. FIG. 1 merely shows the components essential to the description of an exemplary embodiment of the present disclosure, and actual implementation may include more or fewer components.

Hereinafter, descriptions are made of individual components.

The AVNT terminal 110 may provide functions such as communication and data transmission with the external environment through telematics technology, route guidance (navigation) based on electronic maps, and multimedia playback control. The AVNT terminal 110 may receive commands from passengers through various operation mechanisms such as touch screens, key buttons, and dials. The AVNT terminal 110 according to various exemplary embodiments of the present disclosure may provide profile management functionality and facilitate easier entry into emergency mode by at least partially changing the user interface under the control of the HCU 140, as described later. Further details on this will be elaborated upon later.

The ADAS controller 120 may provide various driver assistance functions based on information obtained through sensors 130. In embodiments of the present disclosure, the ADAS controller 120 may deactivate at least some driver assistance functions which may hinder the rapid arrival at the emergency destination when the emergency mode is activated. The driver assistance functions which may be deactivated in emergency mode may include navigation-based smart cruise control (NSCC), intelligent speed limit assist (ISLA) for limiting intelligent speed limit assist (ISLA) for limiting the maximum vehicle speed to a set speed, or manual speed limit assist (MSLA) for setting the maximum vehicle speed to a preset limit. However, this is illustrative and not necessarily limited thereto, and any driver assistance function which may hinder or inhibit driving performance, such as acceleration, in an emergency situation may fall under the present category.

The sensors 130 may include a plurality of sensors that detect the state of the vehicle 100. For example, the sensors 130 may include, but are not limited to, an accelerometer, a wheel speed sensor, and an inclinometer.

The HCU 140 may function as a higher-level controller that integrates and is configured to control the overall functions of the hybrid vehicle. For example, the HCU 140 may be configured to determine the required torque based on the acceleration pedal operation and distribute torque to each drive unit according to driving conditions to satisfy the required torque. In embodiments of the present disclosure, the HCU 140 may perform overall decision-making and control necessary for providing emergency mode and may be referred to as an “emergency mode controller.” Furthermore, the HCU 140 may be configured to determine whether a pregnant woman is on board based on user profiles, prepare for emergency mode entry (i.e., emergency mode preparation control) upon determining that a pregnant woman is on board, and upon entering emergency mode, perform optimal route control and emergency driving control based on information obtained through the AVNT terminal 110 and sensors 130. In implementation, depending on the vehicle type, the HCU 140 may be replaced by a different form of higher-level controller, such as a vehicle control unit (VCU), in the case of electric vehicles, or other controllers such as ADAS controllers in conventional internal combustion engine vehicles where there is no higher-level controller.

Alternatively, the ADAS controller 120 and the HCU 140 may be integrated in a single processor.

Hereinafter, the operation of the emergency mode in an exemplary embodiment of the present disclosure is described based on the vehicle configuration outlined above.

FIG. 2 is a schematic diagram illustrating a conceptual outline of emergency mode control according to an exemplary embodiment of the present disclosure.

With reference to FIG. 2, upon detecting a pregnant woman on board the vehicle, the HCU 140 may change the graphical user interface (GUI) by initiating emergency mode preparation, displaying an emergency mode entry button on the touchscreen of the AVNT terminal 110. The HCU 140 may also change the user interface by mapping the emergency mode entry function to a specific button on the steering wheel. Such emergency mode preparation measures may facilitate a quicker entry into the emergency mode. In such a state, when an emergency situation arises at step S210, the occupants may input an emergency mode entry command at step S220, and the HCU 140 may execute emergency control at step S230. As described above, the emergency control may include recommending and guiding routes prioritizing the safety of pregnant women and controlling vehicle behavior during guidance.

The interface is a component configured for outputting electrical signals according to the on or off operations in the vehicle, through which the user can selectively manipulate the on or off operations in the vehicle, and may include, for example, an operating device such as a button or switch provided in the vehicle, an input device of the AVNT or a touchscreen.

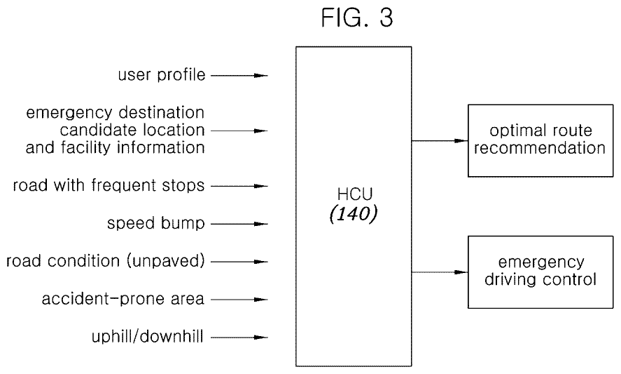

FIG. 3 is a diagram exemplifying emergency mode control according to an exemplary embodiment of the present disclosure.

With reference to FIG. 3, upon entering emergency mode, the HCU 140 may recommend the optimal route and emergency driving control, with the input information including user profiles (e.g., name, age, preferred settings, pregnancy flag., etc.), emergency destination information (e.g., hospital location), road information (roads with frequent stops, speed bumps, unpaved/under construction roads, accident-prone areas, uphill/downhill roads), and facility information (e.g., size, number of beds, medical departments and availability of emergency rooms). The input information such as the user profiles, emergency destination location information, and road information may be obtained through the AVNT terminal 110.

In the optimal route recommendation function among the features provided through the emergency mode, the optimal route may be determined by quantifying the route factors and facility factors for each emergency destination candidate and determining the score. Here, the route factors may include emergency destination location information (e.g., hospital location) and road information (roads with frequent stops, speed bumps, unpaved/under construction roads, accident-prone areas, uphill/downhill), and the facility factors may include hospital information such as size, number of beds, medical departments (e.g., obstetrics and gynecology), and availability of emergency rooms.

Furthermore, emergency driving control may include deactivating driver assistance functions via the ADAS controller 120 and controlling audio output and broadcasting emergency situations through the AVNT terminal 110. Here, audio control may take the form of playing pre-prepared sounds (such as natural sounds, classical music, or breathing guidance voices) via an output device such as a speaker for the comfort of pregnant women, or reducing external noise through active noise canceling (ANC) function via the output device. Furthermore, emergency situation broadcasting may take the form of situation notifications to a preset emergency contact network using the telematics function of the AVNT terminal 110 (such as text messages or automatic response system (ARS) calls), or arrival notifications to the hospital set as the emergency destination, but this is not necessarily limited to these methods. For example, emergency situation broadcasting may also include transmitting emergency alerts to surrounding vehicles via the telematics center or vehicle-to-everything (V2X) communication.

Next, a description includes the method for determining the emergency destination within the optimal route recommendation function among the emergency mode features.

As described above, the HCU 140 may derive the optimal route to the emergency destination and score factors affecting the safety of pregnant women, and a specific example of scoring each factor is as follows.

### 1) Distance to the Hospital

When entering emergency mode, the HCU 140 searches for nearby hospitals and is configured to determine the distances to the nearby hospitals. Scores may be assigned to nearby hospitals in descending order within a predetermined distance based on the distance from the current location, with the highest score (e.g., 10 points) assigned to the nearest hospital.

### 2) Hospital Information

The HCU 140 may aggregate data such as hospital size, number of beds, presence of obstetrics and gynecology department, and availability of emergency rooms for each hospital to score the hospitals.

3) Roads with Frequent Stops

The HCU 140 may assign scores to hospitals in descending order based on the length of congestion zones (navigation red zones), starting with the hospital having the shortest length of red zones.

### 4) Unpaved Roads (Road Conditions)

The HCU 140 may assign scores to hospitals based on the total length of unpaved road segments, similar to how it consider roads with frequent stops.

### 5) Speed Bumps

The HCU 140 may factor in the number of speed bumps along the route by deducting points from a predefined maximum score.

### 6) Accident-Prone Areas

The HCU 140 may apply a deduction method similar to that of speed bumps based on the number of accident-prone areas, subtracting points from a predefined maximum score.

The listed factors are illustrative examples, and consideration of all factors is not necessary; fewer or more factors may be taken into account. For example, four types of factors may be considered as shown in Table 1.

TABLE 1

| | Hospital 1 | Hospital 2 | Hospital 3 | Hospital 4 |
|---|---|---|---|---|
| Distance | 10 | 8 | 6 | 4 |
| Congestion zone | 6 | 8 | 10 | 4 |
| Road condition | 8 | 10 | 4 | 6 |
| Speed bump | 6 | 8 | 4 | 10 |
| Total score | 30 | 34 | 24 | 24 |

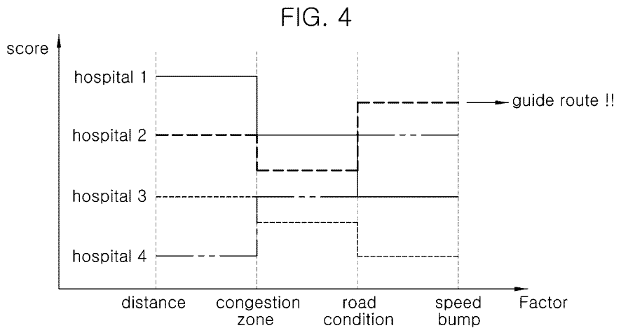

Table 1 may be shown as a graph in FIG. 4. FIG. 4 is a diagram illustrating a method for determining the optimal emergency destination according to an exemplary embodiment of the present disclosure.

Based on Table 1 and FIG. 4, the HCU 140 may prioritize Hospital 2, which attains the highest total score, as the emergency destination, enabling the AVNT terminal 110 to offer route guidance.

Depending on the implementation, some of the processes involved in the final selection of the emergency destination by quantifying factors, as described above, may be executed by the AVNT terminal 110 instead of the HCU 140.

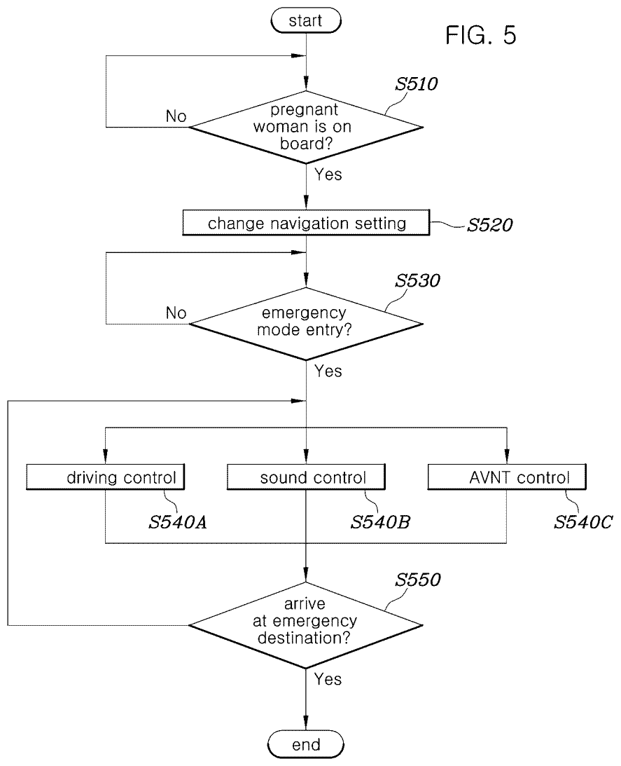

The emergency mode control process described in the exemplary embodiment so far may be depicted as a flowchart in FIG. 5.

FIG. 5 is a flowchart illustrating an exemplary process of emergency mode control according to an exemplary embodiment of the present disclosure.

With reference to FIG. 5, it may be determined at step S510 whether a pregnant woman is on board. The HCU 140 may be configured to determine whether a pregnant woman is on board based on the selection of a profile with a pregnant woman setting on the AVNT terminal 110, but this is provided as an example and not necessarily the only method. For example, the determination of whether a pregnant woman is on board may be based on factors such as adjusting the seat position backward to maintain space between the steering wheel and abdomen, as well as methods like facial recognition or manually inputting the presence of a pregnant woman through menu operations.

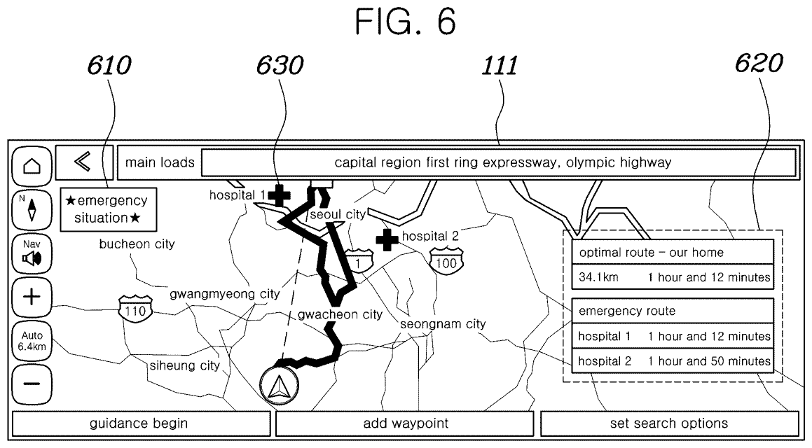

When it is determined at step S510 that a pregnant woman is on board, the HCU 140 may be configured for controlling the AVNT terminal 110 to change the navigation settings accordingly at step S520. Here, changing the navigation settings may take the form of adding an emergency mode entry button to the display of the terminal 110 as portion of the emergency mode preparation control described above. The navigation settings change will be described in more detail with reference to the illustration in FIG. 6. According to an exemplary embodiment of the present disclosure, in preparation for the emergency mode with a pregnant woman on board, the HCU 140 may assign the emergency mode entry command function to a predetermined key button (e.g., a button on the steering wheel).

Subsequently, upon receiving the input of the emergency mode entry command at step S530, the HCU 140 may enter the emergency mode to execute emergency driving control at step S540A and control of the AVNT terminal 110 at step S540C for optimal route recommendation. The HCU 140 may also execute sound control at step S540B upon entering emergency mode.

The emergency driving control executed at step S540A may involve selectively managing, e.g., deactivating, functions that hinder acceleration of the vehicle (e.g., NSCC, ISLA, MSLA, etc.) during the trip of the vehicle to the emergency destination via the ADAS controller 120. Meanwhile, sound control at step S540B may refer to audio output for stability guidance. Furthermore, the control of the AVNT terminal 110 at step S540C may include route guidance based on the emergency destination determination and communication through the emergency contact network via the telematics function.

The aforementioned emergency mode controls at steps S540A, S540B, and S540C may continue until it is determined at step S550 that the vehicle reaches the emergency destination.

FIG. 6 is an exemplary screen display of navigation setting changed based on the determination of pregnant women boarding according to an exemplary embodiment of the present disclosure.

With reference to FIG. 6, when the HCU 140 initiates the emergency mode preparation process based on the determination of a pregnant woman being on board, the display 111 of the AVNT terminal 110 may show a route search screen reflecting the changed navigation settings.

In more detail, when the navigation settings are changed, an emergency mode entry button 610 may be additionally displayed in a designated area on the display 111. Additionally, during route search, route information 620 for each emergency destination candidate, in addition to the destination entered by the occupant, may also be displayed. Furthermore, icons 630 representing the locations corresponding to the emergency destination candidates (in the instant case, hospitals) may be displayed on the map.

According to the described embodiments, in the event of an emergency situation occurring in a vehicle with a pregnant woman on board, ensuring the safety of the pregnant woman while rapidly reaching the destination can reduce potential risks.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for controlling a vehicle, the method comprising:
determining whether a pregnant woman is on board; and
performing emergency mode control, based on the determination of the pregnant woman being on board and an emergency mode entry command being input,
wherein the emergency mode control includes:
route guidance control to an emergency destination determined based on a predetermined criteria; and
emergency driving control to selectively control an acceleration-inhibiting driving assistance function to the determined emergency destination.

2. The method of claim 1, wherein the performing of the emergency mode control includes deactivating the acceleration-inhibiting driving assistance function to the emergency destination.

3. The method of claim 2, wherein the acceleration-inhibiting driving assistance function includes at least one of navigation-based smart cruise control (NSCC), intelligent speed limit assist (ISLA) for limiting a maximum vehicle speed to a set speed, or manual speed limit assist (MSLA).

4. The method of claim 1, wherein the predetermined criteria include route factors and facility factors scored for each of at least one emergency destination candidate.

5. The method of claim 4,
wherein the route factors include location and road information along a route of the vehicle for each emergency destination candidate, and
wherein the facility factors include at least one of size, number of beds, availability of emergency rooms, and medical departments for each emergency destination candidate.

6. The method of claim 1, wherein the determining of whether the pregnant woman is on board includes determining whether a profile with the pregnant woman setting applied is selected.

7. The method of claim 1, further including performing, based on the determination of the pregnant woman being on board, emergency mode preparation control inclusive of changing navigation settings.

8. The method of claim 7, wherein the performing of the emergency mode preparation control includes displaying a menu for entering the emergency mode on a display of a navigation device.

9. The method of claim 1, wherein the emergency mode control further includes:
a sound control including at least one of outputting predetermined audio and activating active noise cancellation; and
an emergency contact control to the determined emergency destination and a predetermined contact.

10. A non-transitory computer-readable recording medium storing a program for executing the method of claim 1.

11. A vehicle comprising:
an advanced driver assistance system (ADAS) controller;
an audio/video/navigation/telematics (AVNT) terminal; and
an emergency mode controller operatively connected to the ADAS controller and the AVNT terminal and configured to perform, based on determination of a pregnant woman being on board and an emergency mode entry command being input to the emergency mode controller, emergency mode control including route guidance control and emergency mode control,
wherein the route guidance control includes guiding a route of the vehicle to a determined emergency destination via the AVNT terminal based on a predetermined criteria, and
wherein the emergency driving control includes selectively controlling an acceleration-inhibiting driving assistance function provided through the ADAS controller to the determined emergency destination.

12. The vehicle of claim 11, wherein the emergency mode controller is further configured to deactivate the acceleration-inhibiting driving assistance function to the emergency destination.

13. The vehicle of claim 12, wherein the acceleration-inhibiting driving assistance function includes at least one of navigation-based smart cruise control (NSCC), intelligent speed limit assist (ISLA) for limiting a maximum vehicle speed to a set speed, or manual speed limit assist (MSLA).

14. The vehicle of claim 11, wherein the predetermined criteria include route factors and facility factors scored for each of at least one emergency destination candidate.

15. The vehicle of claim 14,
wherein the route factors include location and road information along the route of the vehicle for each emergency destination candidate, and
wherein the facility factors include at least one of size, number of beds, availability of emergency rooms, and medical departments for each emergency destination candidate.

16. The vehicle of claim 11, wherein the emergency mode controller is further configured to determine whether a profile with the pregnant woman setting applied is selected.

17. The vehicle of claim 11, wherein the emergency mode controller is configured to perform, based on the determination of the pregnant woman being on board, emergency mode preparation control inclusive of changing navigation settings.

18. The vehicle of claim 17, wherein the changing of the navigation settings includes displaying a menu for entering the emergency mode on a display of the AVNT terminal.

19. The vehicle of claim 11, wherein the emergency mode control further includes:
a sound control including at least one of outputting predetermined audio and activating active noise cancellation; and
an emergency contact control to the determined emergency destination and a predetermined contact.

20. The vehicle of claim 11,
wherein the vehicle includes a hybrid vehicle or an electric vehicle, and
wherein the emergency mode controller includes a hybrid control unit (HCU) for the hybrid vehicle or a vehicle control unit (VCU) for the electric vehicle.
